(19) United States
(12) Patent Application Publication
(10) Pub. No.: US 2026/0039972 A1
(43) Pub. Date: Feb. 5, 2026

(54) SHARED HIGH DYNAMIC RANGE ROLLING SHUTTER ARCHITECTURE WITH LATERAL OVERFLOW INTEGRATION CAPACITOR SHUFFLE-GATE EXTENSION

(71) Applicant: AIStorm Inc., Houston, TX (US)

(72) Inventor: Scott JOHNSON, Houston, TX (US)

(73) Assignee: AIStorm Inc., Houston, TX (US)

(21) Appl. No.: 19/288,496

(22) Filed: Aug. 1, 2025

Related U.S. Application Data
(60) Provisional application No. 63/678,837, filed on Aug. 2, 2024.

(51) Int. Cl. H04N 25/59; H04N 25/531; H04N 25/771; H04N 25/78

(52) U.S. Cl. CPC H04N 25/59; H04N 25/531; H04N 25/771; H04N 25/78

(57) ABSTRACT

A pixel architecture is provided for complementary metal-oxide-semiconductor (CMOS) image sensors for high dynamic range (HDR) capture without introducing multi-exposure motion blur. The pixel architecture combines a low-noise readout in combination with a shuffle-gate circuit which is used for flexible extension of sensor saturation. The shuffle-gate circuit allows for the overflow charge from a photodiode to be selectively skimmed and stored based on a modulated duty cycle that governs signal range extension. Shared elements allow for further pixel size reduction through wafer-to-wafer interconnects and spatial multiplexing.

### CROSS-REFERENCE TO RELATED APPLICATIONS

This application claims priority of U.S. Provisional Patent Application Ser. No. 63/678,837 filed Aug. 2, 2024; the contents of which are incorporated herein by reference in their entirety.

### TECHNICAL FIELD

The present invention relates generally to complementary metal-oxide-semiconductor (CMOS) image sensors and more particularly to pixel-level circuit architectures for achieving high dynamic range (HDR) imaging.

### BACKGROUND

Complementary metal-oxide-semiconductor (CMOS) image sensors convert light captured by a lens into electrical signals for digital processing. Image sensors may be formed with an array of pixels arranged in rows and columns on the image sensor surface, where each of the pixels collects photons that are converted into photoelectrons using a photodiode for generating charge in response to incident light. Image pixels may also include a charge storage region for storing charge that is generated in the photodiode. The number of pixels in an image sensor may vary widely, ranging from hundreds to millions (e.g., megapixels). Image sensors may operate using a global shutter or a rolling shutter scheme. The multiple pixels that cover the surface of the sensor allow for both a determination of number of photons detected, and the location of these photons.

In addition to the pixel array, image sensors generally include control circuitry for pixel operation and readout circuitry to retrieve the image signals generated by the photosensitive elements. The readout circuitry may be coupled to each pixel column of the array for reading out image signals from the image pixels. Image sensors are commonly used in electronic devices including cellular telephones, cameras, automobiles, augmented reality (AR) and virtual reality (VR) headsets, robots, factory automation and inspection systems, weapon systems, and computers to capture images.

Conventional approaches to high dynamic range (HDR) imaging with complementary metal-oxide-semiconductor (CMOS) image sensors often employ multi-exposure imaging techniques, which are prone to motion artifacts when capturing dynamic scenes. Lateral Overflow Integration Capacitor (LOFIC) techniques may be used to enhance HDR in CMOS image sensors. However, LOFIC do not scale to smaller pixel pitches, or to multi-photodiode architectures, which also do not scale to smaller sizes.

FIG. 1 is a prior art schematic circuit diagram of an industry standard four transistor (4T) CMOS pixel structure 10 which includes a photodiode PD which captures incident photons and converts them to an electronic charge, a transfer gate Tx which is set to transfer the charge from the photodiode after a predetermined integration time, a floating diffusion node FD which converts the transferred charge to a voltage, a source follower SF which acts as an infinite impedance buffer to mirror a relative voltage from the floating diffusion node FD to the column readout circuitry, a row select gate (Select) which connects the output of the source follower SF to the Voutput line Vout which carries the signal to column readout circuitry, and a reset transistor Rst which is used to reset the floating diffusion node FD and the photodiode PD.

While there have been many advancements in image sensors, and in particular complementary metal-oxide-semiconductor (CMOS) image sensors, there continues to be a need for improved pixel designs that provide extended dynamic range, motion fidelity, and compact form factors without sacrificing image quality.

### SUMMARY

A complementary metal-oxide-semiconductor (CMOS) image sensor pixel is provided. The CMOS image sensor pixel includes a photodiode; a floating diffusion node at a cathode of a reverse biased diode; a transfer gate connected between the photodiode and the floating diffusion node; a source follower gate connected to the floating diffusion node; a row select gate which connects an output of the source follower gate to a Voutput line; a reset transistor connected to the floating diffusion node; and a skim transistor connected between the floating diffusion node and a virtually pinned diode, the virtually pinned diode further connected to a shuffle store gate and a shuffle reset gate, where the shuffle store gate is connected to ground via an integrating capacitor, and the shuffle reset gate is connected to a shuffle supply line connected to a voltage supply.

An array of CMOS image sensor pixels is provided that includes a plurality of CMOS image sensor pixels arranged in columns and rows with a separate row control line for each row, and a separate column readout line for each column, where each CMOS image sensor pixel includes: a photodiode; a floating diffusion node at a cathode of a reverse biased diode; a transfer gate connected between the photodiode and the floating diffusion node; a source follower gate connected to the floating diffusion node; a row select gate which connects an output of the source follower SF to a Voutput line, where the Voutput line is connected to the column readout line for the particular pixel; a reset transistor connected to the floating diffusion node; and a skim transistor connected between the floating diffusion node and a virtually pinned diode, the virtually pinned diode further connected to a shuffle store gate and a shuffle reset gate, where the shuffle store gate is connected to ground via an integrating capacitor, and the shuffle reset gate is connected to a shuffle supply line connected to the row control line, where the row control line is connected to a voltage supply.

An image sensor is provided that includes: a control circuit in electrical communication with a row decoder and row driver block and with a column readout circuit, the row decoder and row driver block and the column readout circuit in electrical communication with an array of CMOS image sensor pixels arranged in columns and rows with a separate row control line for each row, and a separate column readout line for each column, where each individual CMOS image sensor pixel of the array includes: a photodiode; a floating diffusion node at a cathode of a reverse biased diode; a transfer gate connected between the photodiode and the floating diffusion node; a source follower gate connected to the floating diffusion node; a row select gate which connects an output of the source follower to a Voutput line, where the Voutput line is connected to the column readout line for the particular pixel; a reset transistor connected to the floating diffusion node; and a skim transistor connected between the floating diffusion node and a virtually pinned diode, the virtually pinned diode further connected to a shuffle store gate and a shuffle reset gate, where the shuffle store gate is connected to ground via an integrating capacitor, and the shuffle reset gate is connected to a shuffle supply line connected to the row control line, where the row control line is connected a voltage supply.

### BRIEF DESCRIPTION OF THE DRAWINGS

The present invention is further detailed with respect to the following drawings that are intended to show certain aspects of the present invention, but should not be construed as a limit on the practice of the present invention.

FIG. 1 is a prior art schematic circuit diagram of a 4T pixel;

FIG. 2 is a schematic circuit diagram of a high dynamic range (HDR) Rolling Shutter with Shuffle Gate lateral overflow integration capacitor (LOFIC) Extension Pixel in accordance with embodiments of the invention;

FIG. 3 is a timing diagram for the HDR Rolling Shutter with Shuffle Gate lateral overflow integration capacitor (LOFIC) Extension Pixel shown in FIG. 2 in accordance with embodiments of the invention;

FIG. 4 is a graph of signal versus exposure rate for the HDR Rolling Shutter with Shuffle Gate LOFIC Extension Pixel shown in FIG. 2 in accordance with embodiments of the invention;

FIG. 5 is a schematic circuit diagram of a 1×n (shown as a 1×4) shared architecture for the HDR Rolling Shutter with Shuffle Gate LOFIC Extension Pixel shown in FIG. 2 in accordance with embodiments of the invention;

FIG. 6 a timing diagram for the 1×n shared architecture for the HDR Rolling Shutter with Shuffle Gate LOFIC Extension Pixel shown in FIG. 5 in accordance with embodiments of the invention;

FIG. 7 is a schematic diagram of a pixel array system formed with HDR Rolling Shutter with Shuffle Gate LOFIC Extension Pixels in accordance with embodiments of the invention; and

FIG. 8 is a schematic diagram of the pixel array system of FIG. 7 in an imaging system in accordance with embodiments of the invention.

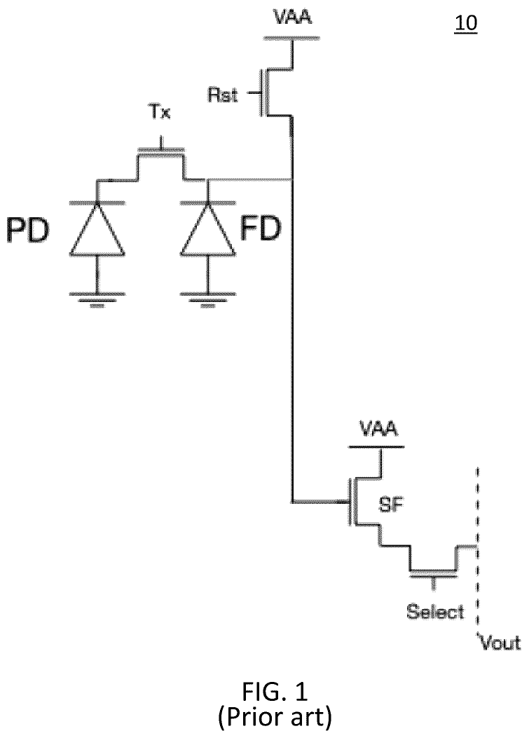

It is understood that like reference characters refer to like elements throughout the several figures.

### DETAILED DESCRIPTION

Novel pixel architectures for CMOS image sensors are provided that enable high dynamic range (HDR) capture without introducing multi-exposure motion blur. Embodiments of the pixel architecture combine a low-noise readout in combination with a shuffle-gate circuit which is used for flexible extension of sensor saturation. The shuffle-gate circuit allows for the overflow charge from the photodiode to be selectively skimmed and stored based on a modulated duty cycle that governs signal range extension. Shared elements allow for further pixel size reduction through wafer-to-wafer interconnects during fabrication that reduces overall pixel pitch and allows for spatial multiplexing.

It will be understood by those skilled in the art that the described embodiments may be implemented with or without certain specific details. In some cases, well-known techniques or processes are not described in full detail so as not to obscure the essential features of the invention.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

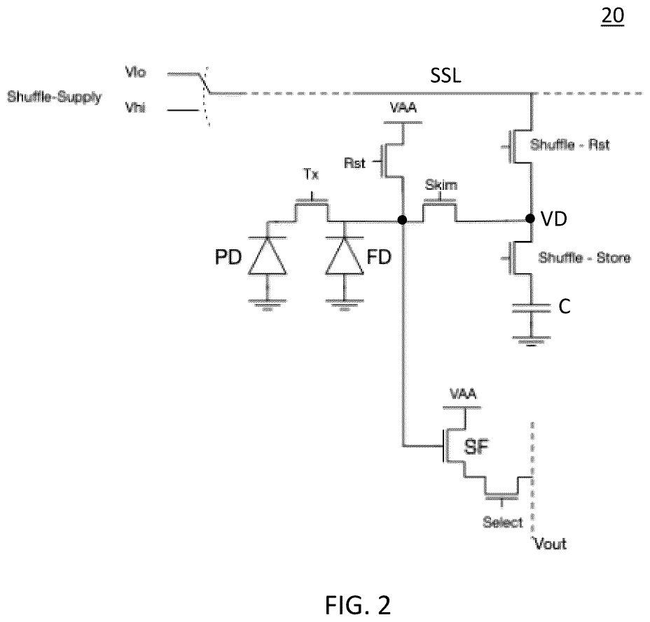

The preferred embodiments of the present invention will be hereinafter described with reference to the figures. FIG. 2 is a schematic circuit diagram of a pixel 20 of an embodiment of the HDR Rolling Shutter with Shuffle Gate LOFIC Extension Pixel invention. The pixel 20 incorporates a Photodiode PD which captures incident photons and converts them to an electronic charge, a transfer gate Tx which is set to transfer the charge from the photodiode after a predetermined integration time, a floating diffusion node FD which converts the transferred charge to a voltage, a source follower SF which acts as an infinite impedance buffer to mirror a relative voltage from the floating diffusion node FD to the column readout circuitry, a row select gate Select which connects the output of the source follower SF to the Voutput line which carries the signal to the column readout circuitry, and a reset transistor Rst which is used to reset the floating diffusion node FD and the photodiode PD; these first elements act as the ‘low light’ sensing portion of the pixel circuit 20. Additionally, the pixel 20 includes a skim transistor Skim connected to the floating diffusion node FD which is set to a predetermined level intended to coincide with a higher electron count in the floating diffusion FD. The skim transistor Skim is also connected to a virtually pinned diode VD which is connected to two shuffle gates (Shuffle-Rst, Shuffle-Store). The first shuffle gate is a reset-shuffle gate (Shuffle-Rst) which takes incoming electrons from the virtual pinned diode and sweep them away to a high potential node. The second shuffle gate (Shuffle-Store) is connected to an integrating capacitor C which stores the signal to be readout at a later time. The second shuffle gate (Shuffle-Store) may be a kind of notch gate which allows for a portion of charge to be transferred back from the integrating capacitor C to the floating diffusion node FD. The two shuffle gates (Shuffle-Rst, Shuffle-Store) are alternatingly activated, which may be in an asynchronous manner, where the duty cycle between the two dictating the dynamic range extension. A shuffle supply line SSL is shared for the entire row of pixels and can either be set to a ‘high’ value or a ‘low value’ by a voltage supply (Shuffle-Supply) depending on the operational timing. In a specific embodiment, the floating diffusion node is pre-charged prior to integration by activating the skim gate and shuffle-reset gate using a low voltage. In a specific embodiment, the photodiode PD and transfer gate Tx are shared among multiple pixels, and the shuffle store integrating capacitor C is scaled accordingly.

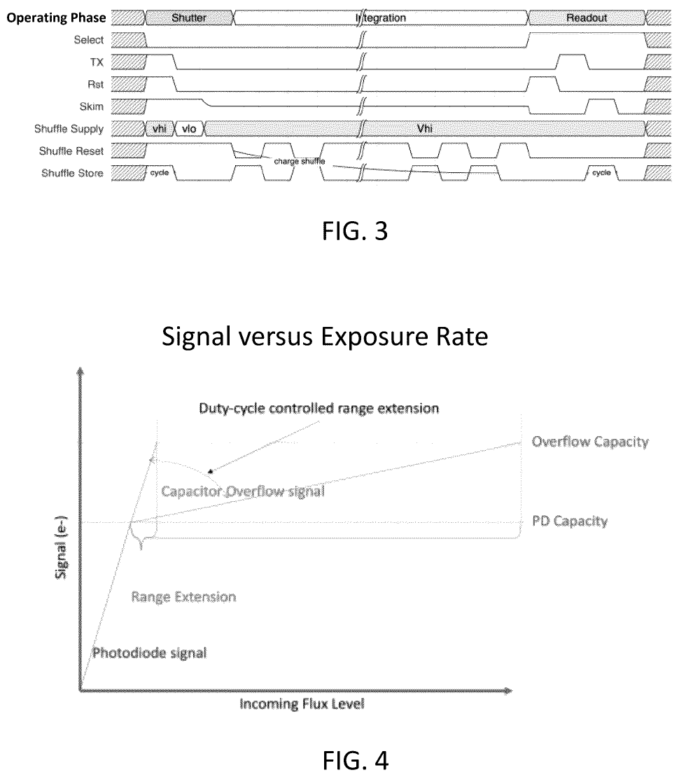

FIG. 3 is a timing diagram for operation of the pixel embodiment 20 shown in FIG. 2, where three phases of operation are shown including shutter, integration, and readout. In the Shutter phase, the row select is not asserted to ensure pixel operation of the selected row does not interfere with the readout operation of subsequent rows. The Tx Gate, Rst, Skim, Shuffle-Reset, and Shuffle-Store are all asserted to a high value while the shared shuffle supply signal is at a high state to remove all charge from the integrating nodes. In the event that the shuffle-store transistor is a notch gate, the notch gate may have to be cycled a number of times to completely remove the charge. A notched gate in CMOS (Complementary Metal-Oxide-Semiconductor) technology refers to a specific gate structure where the gate electrode is intentionally recessed or notched, typically near the source and drain regions. This design modification is implemented to improve the performance and reduce the parasitic capacitance of MOSFETs, particularly in advanced CMOS technologies. The Tx, Rst, and Shuffle-Store are then deasserted as the Shuffle-Supply transitions to a lower voltage and the Skim and shuffle-reset transistors remain asserted for a time, after which the Skim gate is set to a predetermined level and the Shuffle supply is set back High. this is done to set the effective OV pinning of the virtual pinned diode equal to that of the skim gate potential.

In the integration phase, incoming photons are converted to an electronic charge and stored in the pinned photo diode PD. If the incoming signal accumulation exceeds the level of the transfer gate's (Tx's) barrier, the electrons will then start to overflow to the floating diffusion node FD. The two shuffle gates (Shuffle-Rst, Shuffle-Store) are set to alternatingly change between high and low potentials to allow for the charge which may be overflowing from the floating diffusion to the virtual pinned diode to either the Shuffle Supply or the integrating capacitor C. The longer the time is spent on the integrating capacitor C, the lower the range extension will be, but higher the signal to noise ratio will be for the given exposure time.

During the readout phase the row-select gate Select is enabled in order to connect the selected row to the column readout line. A four transistor (4T) sampling pattern performed at first by having the reset gate Rst asserted, and this reset value is sampled by the column circuitry. The transfer gate Tx is then asserted, transferring charge from the photodiode PD to the floating diffusion node FD, this signal level is then sampled. The difference between this signal level from the transfer gate Tx and the reset signal is the correlated double sampled low-light value. Lastly the skim gate Skim is asserted and the shuffle-store gate (Shuffle-Store) is asserted to sample the overflowed charge. In the event that the shuffle-store gate (Shuffle-Store) is a notch gate, the notch gate would be cycled a number of times to ensure all charge is removed and sampled by the column circuitry.

FIG. 4 is a graph of the signal vs. exposure time for the pixel embodiment 20 shown in FIG. 2. The X-axis is the exposure level and the Y-axis is the signal level in electrons. The photodiode PD signal is linear up to the saturation level of the photodiode PD which is set by the overflow level of the transfer gate Tx, subsequently the integrating capacitor C signal level is then variable based on the duty cycle between the shuffle-reset and shuffle-store gates.

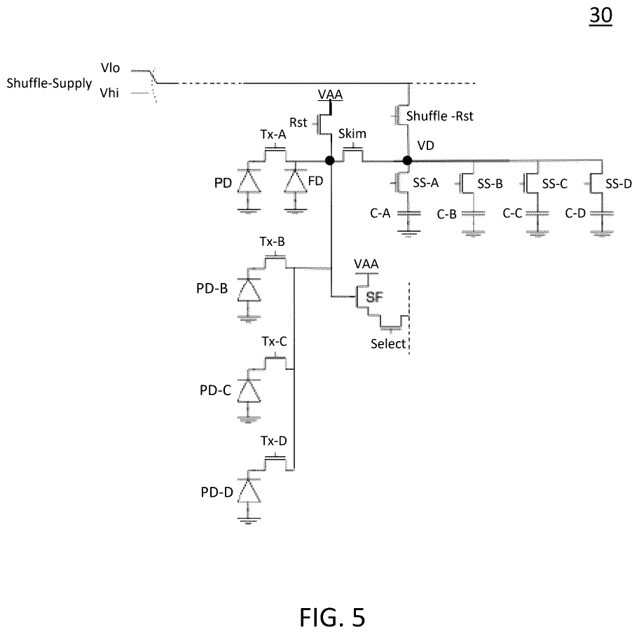

FIG. 5 is a pixel embodiment 30 with a shared architecture for the HDR Rolling Shutter with Shuffle Gate LOFIC ExtensionPixel, specifically a 1×4 arrangement where the original circuit architecture from FIG. 2 is augmented with three additional photodiodes (PD-B, PD-C, PD-D) and transfer gates (Tx-B, Tx-C, Tx-D) to connect to the floating diffusion node FD and three additional shuffle-store gates (SS-B, SS-C, SS-D) plus three additional integrating capacitors (C-B, C-C, C-D) connected to the virtually pinned skimming diode VD.

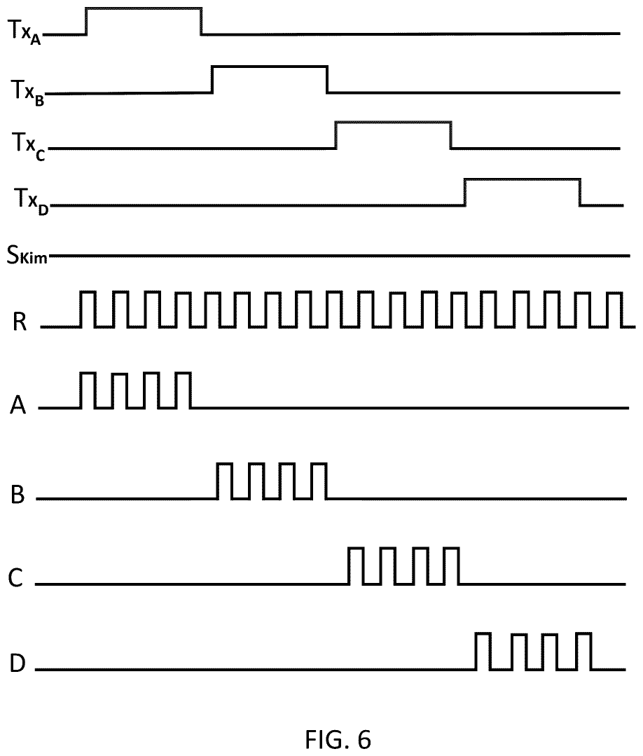

FIG. 6 is the timing diagram for the pixel embodiment 30 in FIG. 5. The timing is similar to the operation shown in FIG. 3 with the addition of the added shared integrating capacitors (C-B, C-C, C-D) and added shuffle-store gates (SS-B, SS-C, SS-D) all taking turns shuffling the overflowing charge from the respective photodiodes by dynamically changing the transfer gate levels (Tx-A, Tx-B, Tx-C, Tx-D). The different transfer gates (Tx-A, Tx-B, Tx-C, Tx-D) are modulated from an ‘off state’ to a ‘leaky state’, corresponding to the different skimming gate Skim and integrated circuit (IC) operations. The shuffle-reset signal R is set to alternate between the shuffle-store A/B/C/D gates (SS-B, SS-C, SS-D). The duty cycles (shown as A/B/C/D signals) of the shuffle-store A/B/C/D gates (SS-B, SS-C, SS-D) along with the reset shuffle sets the HDR extension. In pixel embodiment 30, the skim gate Skim may need to be fully enabled to remove FD integration.

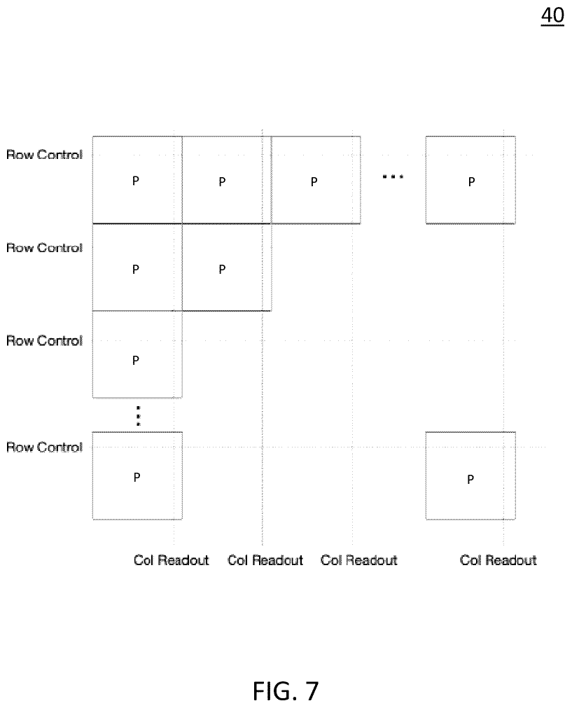

FIG. 7 is a schematic diagram of a pixel array system 40 formed with embodiments of the HDR Rolling Shutter with Shuffle Gate LOFIC Extension Pixels (20, 30). The pixel array system 40 is shown as an array of periodic blocks P that represent embodiments of the pixels (20, 30) and are connected in rows and columns. The column readout line is shared between all pixels in a column as well as all routed ground and voltage supply lines. The row control and readout lines including the Tx, Rst, RS, Skim, Shuffle-Store, and Shuffle-Rest gates are all shared along the row lines.

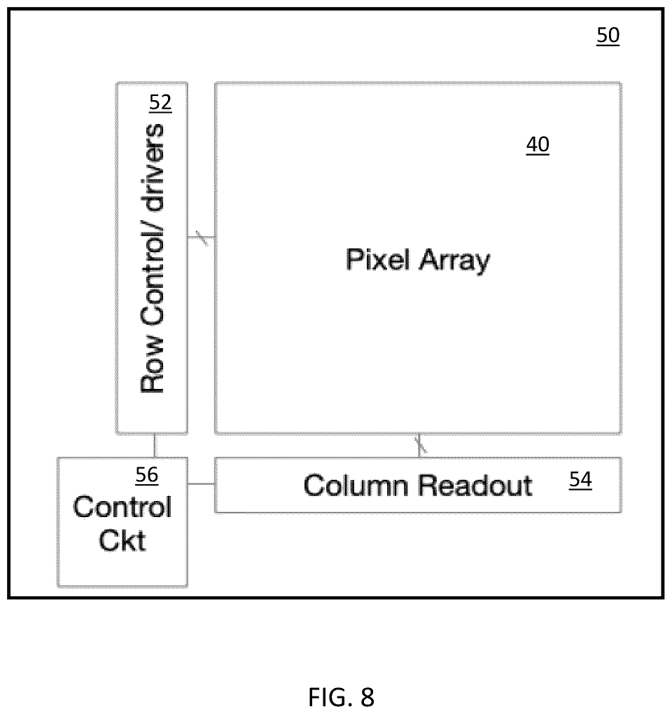

FIG. 8 is a schematic diagram of the pixel array system of FIG. 7 in an image sensor 50. The pixel array 40 is connected to both the row decoder and row driver block 52, in addition the pixel array 40 is connected to the column readout circuitry 54. Both the column readout circuitry 54 and the row decoder and drivers 52 are connected to a control circuit 56. In specific embodiments, the control circuit 56 may be configured to modulate the shuffle-reset gate Rst and the shuffle-store gate SS based on a predetermined duty cycle during integration, where overflow charge from the photodiode PD is diverted through the skim gate Skim to the shuffle-store capacitor C based on the duty cycle. In specific embodiments, the shuffle-reset gate Rst and the shuffle store gate SS are operated asynchronously with respect to the integration timing to reduce motion blur. In a specific embodiment, the floating diffusion node FD is pre-charged prior to integration by activating both the skim gate Skim and shuffle-reset gate Rst using a low voltage.

While the preferred embodiments of the present invention have been disclosed herein, it will be appreciated that modification of these particular embodiments of the invention may be resorted to without departing from the scope of the invention as found in the appended claims.

Various modifications of the present invention, in addition to those shown and described herein, will be apparent to those skilled in the art of the above description. Such modifications are also intended to fall within the scope of the appended claims.

The foregoing description is illustrative of particular embodiments of the invention, but is not meant to be a limitation upon the practice thereof. The following claims, including all equivalents thereof, are intended to define the scope of the invention.

1. A complementary metal-oxide-semiconductor (CMOS) image sensor pixel comprising:
a photodiode;
a floating diffusion node at a cathode of a reverse biased diode;
a transfer gate connected between the photodiode and the floating diffusion node;
a source follower gate connected to the floating diffusion node;
a row select gate which connects an output of the source follower gate to a Voutput line;
a reset transistor connected to the floating diffusion node;
a skim transistor connected between the floating diffusion node and a virtually pinned diode, the virtually pinned diode further connected to a shuffle store gate and a shuffle reset gate, where the shuffle store gate is connected to ground via an integrating capacitor, and the shuffle reset gate is connected to a shuffle supply line connected to a voltage supply.

2. The CMOS image sensor pixel of claim 1, wherein the transfer gate is set to transfer a charge from the photodiode after a predetermined integration time, and the floating diffusion node converts the transferred charge to a voltage.

3. The CMOS image sensor pixel of claim 2, wherein the source follower acts as an infinite impedance buffer to mirror the voltage from the floating diffusion node FD to provide an output signal voltage to the Voutput line; and
wherein the Voutput line is connected to column readout circuitry.

4. The CMOS image sensor pixel of claim 1, wherein the reset transistor resets the floating diffusion node and the photodiode.

5. The CMOS image sensor pixel of claim 1, wherein the skim transistor is set to a predetermined level to coincide with an electron count in the reverse biased diode.

6. The CMOS image sensor pixel of claim 1, wherein the integrating capacitor stores the output signal voltage.

7. The CMOS image sensor pixel of claim 1, wherein the shuffle store gate is a notch gate.

8. The CMOS image sensor pixel of claim 1 further comprising additional photodiodes and corresponding additional transfer gates connected in parallel to the floating diffusion node, as well as, additional shuffle store gates and corresponding additional integrating capacitors connected to the virtually pinned diode.

9. An array of CMOS image sensor pixels, the array comprising:
a plurality of CMOS image sensor pixels arranged in columns and rows with a separate row control line for each row, and a separate column readout line for each column, where each CMOS image sensor pixel comprises:
a photodiode;
a floating diffusion node at a cathode of a reverse biased diode;
a transfer gate connected between the photodiode and the floating diffusion node;
a source follower gate connected to the floating diffusion node;
a row select gate which connects an output of the source follower SF to a Voutput line, where the Voutput line is connected to the column readout line for the particular pixel;
a reset transistor connected to the floating diffusion node; and
a skim transistor connected between the floating diffusion node and a virtually pinned diode, the virtually pinned diode further connected to a shuffle store gate and a shuffle reset gate, where the shuffle store gate is connected to ground via an integrating capacitor, and the shuffle reset gate is connected to a shuffle supply line connected to the row control line, where the row control line is connected to a voltage supply.

10. The pixel array of claim 9, wherein for each individual pixel the transfer gate is set to transfer a charge from the photodiode after a predetermined integration time, and the floating diffusion node converts the transferred charge to a voltage.

11. The pixel array of claim 10, wherein the source follower acts as an infinite impedance buffer to mirror the voltage from the floating diffusion node to provide an output signal voltage to the Voutput line.

12. The pixel array of claim of claim 9, wherein for each individual pixel the shuffle store gate is a notch gate.

13. The pixel array of claim of claim 9, further comprising for each individual pixel additional photodiodes and corresponding additional transfer gates connected in parallel to the floating diffusion node, as well as, additional shuffle store gates and corresponding additional integrating capacitors connected to the virtually pinned diode.

14. The pixel array of claim of claim 9, wherein pixel size is reduced through wafer-to-wafer interconnects during fabrication that reduces overall pixel pitch and allows for spatial multiplexing.

15. An image sensor comprising:
a control circuit in electrical communication with a row decoder and row driver block and with a column readout circuit, the row decoder and row driver block and the column readout circuit in electrical communication with an array of CMOS image sensor pixels arranged in columns and rows with a separate row control line for each row, and a separate column readout line for each column, where each individual CMOS image sensor pixel of the array comprises:
a photodiode;
a floating diffusion node at a cathode of a reverse biased diode;
a transfer gate connected between the photodiode and the floating diffusion node;
a source follower gate connected to the floating diffusion node;
a row select gate which connects an output of the source follower to a Voutput line, where the Voutput line is connected to the column readout line for the particular pixel;
a reset transistor connected to the floating diffusion node; and
a skim transistor connected between the floating diffusion node and a virtually pinned diode, the virtually pinned diode further connected to a shuffle store gate and a shuffle reset gate, where the shuffle store gate is connected to ground via an integrating capacitor, and the shuffle reset gate is connected to a shuffle supply line connected to the row control line, where the row control line is connected a voltage supply.

16. The image sensor of claim 15, wherein the control circuit modulates the shuffle reset gate and the shuffle store gate based on a predetermined duty cycle during integration, where overflow charge from the photodiode is diverted through the skim gate to the integrating capacitor based on the duty cycle.

17. The image sensor of claim 15, wherein the shuffle reset gate and the shuffle store gate are operated asynchronously with respect to integration timing to reduce motion blur.

18. The image sensor of claim 15, wherein the floating diffusion node is pre-charged prior to integration with activation of both the skim gate and the shuffle reset gate using a low voltage level of the voltage supply.

19. The image sensor of claim 15, wherein the control circuit has three phases of operation including:
a shutter phase, where the row select is not asserted to ensure pixel operation of a selected row does not interfere with a readout operation of subsequent rows, and the transfer gate, the reset gate, the skim transistor, the shuffle reset gate, and the shuffle store gate are all asserted to a high value while the shuffle supply signal is at a high state to remove all charge from the floating diffusion node and the virtually pinned diode;
an integration phase, where incoming photons are converted to an electronic charge and stored in the photodiode, where if an incoming signal accumulation exceeds a barrier level of the transfer gate, electrons will then start to overflow charge to the floating diffusion node, and the shuffle reset gate and the shuffle store gate are set to alternatingly change between high and low potentials to allow for the overflow charge to flow to the virtual pinned diode to either the shuffle supply or the integrating capacitor, where the longer a time the overflow charge is spent on the integrating capacitor, the lower a range extension will be, but higher a signal to noise ratio will be for a given exposure time; and
a readout phase where the row select gate is enabled in order to connect a selected row to the column readout line.

20. The image sensor of claim 15, wherein for each individual pixel additional photodiodes and corresponding additional transfer gates are connected in parallel to the floating diffusion node, as well as, additional shuffle store gates and corresponding additional integrating capacitors are connected to the virtually pinned diode.
